(19) United States
(12) Patent Application Publication
(10) Pub. No.: US 2026/0079816 A1
(43) Pub. Date: Mar. 19, 2026

(54) QUALITY LOG ANALYZER

(71) Applicant: MASTERCARD INTERNATIONAL INCORPORATED, Purchase, NY (US)

(72) Inventors: Sushant Kumar, Jharkhand (IN); Gina Marie O'Donnell, St. Charles, MO (US)

(73) Assignee: MASTERCARD INTERNATIONAL INCORPORATED, Purchase, NY (US)

(21) Appl. No.: 18/889,339

(22) Filed: Sep. 18, 2024

(51) Int. Cl. G06F 11/36; G06F 8/41

(52) U.S. Cl. CPC G06F 11/3608; G06F 8/41

(57) ABSTRACT

A system and method for analyzing the quality of data in a server or network component a log file. The system imports a quality log analyzer (QLA) plugin into an integrated developer environment (IDE). The developer application code is compiled within the IDE. The QLA plugin invokes a log analyzer suggestion module (LASM) during the developer application code runtime. During the application code runtime, the LASM, reads the developer application code to parse server log strings associated with the developer application code. The LASM analyzes the developer application code server log strings for similarities, and calculates the similarity between two or more application code server log strings to determine if they are identical, similar, or unrelated. The system uses these comparisons along with an optimized server log rules engine to determine which application code server log strings can be optimized to reduce use of the server log memory.

### TECHNICAL FIELD

The present invention relates to a method of automating the log analysis process to generate an overall summary of the log contents and generates a rating that reflects the quality of the log.

### BACKGROUND

The “background” description provided herein is for the purpose of generally presenting the context of the disclosure. Work of the presently named inventors, to the extent it is described in the background section, as well as aspects of the description which may not otherwise qualify as prior art at the time of filing, are neither expressly nor impliedly admitted as prior art against the present invention.

Computer servers generate and collect vast amounts of data. In order to properly manage all of the data, server operating systems generally create and maintain a log file that registers all the activities a server performs. Most server log files are simple text documents that contain all activities of a specific server over a given period of time. These log files are automatically created by and maintained by the operating system of the server. Server logs can provide detailed information regarding how, when, and by whom a website or application was accessed. The log can also contain information such as the number of page requests, client Internet protocol (IP) addresses, types of IP requests, etc. In addition to client requests, the server logs also gather and collect information related to activities such as system errors, operational details, performance metrics, unauthorized access attempts, and suspicious activities.

The information collected and maintained in server logs is critical to network security and efficiency. Therefore, server logs are accessed often to determine the source of issues related to latency, inefficiencies, network issues, and the like. The accessing of server logs can be done manually, using tools such as text editors, spreadsheet tools, or specialized log analysis tools that automate the process and provide more advanced features. A number of these analysis tools and software products collect, parse, and analyze log data from a variety of sources, such as servers, network devices, and applications. These tools can provide advanced features such as real-time monitoring, alerting, and visualization.

Log analysis tools and software are generally used by system administrators to monitor and debug system or assist in optimizing performance. Log data can help identify issues with systems, such as performance problems or errors, and can provide clues as to the cause of the issue. By analyzing log data, organizations can identify patterns and trends that can help them optimize their systems and improve efficiency. Logs are also used to track user activity and detect security incidents, such as attempted hacks or unauthorized access to sensitive data for security and compliance purposes. While these tools can help identify system issues and optimize performance, they are only as good as the data stored in the logs. In massive data systems, unhandled error messages, un-trapped messages, or runtime errors can create error within a server log. Prior art tools typically “trust” the data that is stored in a server log and generate and analysis based upon the date that is stored therein. These tools do not analyze the data within the log to verify if the information is true and accurate. Corrupted data can lead to further issues and inefficiencies with the servers.

There is currently no tool that can determine the quality of the data that has been logged by a server. What is needed is a system which allows a system administrator or other user to validate the quality of the data in the log itself. Validating the quality of the server log data itself would allow the system to remove the “noise” and reduces storage costs of excessive data.

### SUMMARY

In view of the above needs, a system and method for reducing excessive logging is disclosed herein. The system and method provide a quality log analyzer (QLA) that is designed to determine a desired level of logging required for a given application, including an optimal level. The system and method are designed to reduce noise in the server logs while optimizing the information that is logged. The QLA is designed to provide active scanning of application code executing within an integrated development environment (IDE) or on the network. In an embodiment, the method is accomplished by importing, by a processor, a quality log analyzer (QLA) plugin into an integrated developer environment (IDE). The developer application code is compiled within the IDE. The QLA plugin invokes a log analyzer suggestion module (LASM) during the developer application code runtime. During the application code runtime, the QLA, reads the developer application code to parse server log strings associated with the developer application code. The QLA analyzes the developer application code server log strings for similarities, and calculates the similarity between two or more application code server log strings to determine if they are identical, similar, or unrelated. The QLA also uses a pre-existing dictionary of optimized server log strings, creating a rules engine. The QLA loads the rules engine at runtime for comparison between the server log populated by the application and the optimized server log strings from the rules engine. The algorithm calculates any similarities between the application server log strings and the optimized server log strings from the rules engine and returns a range from 0 (indicating that two or more server log strings are identical), to 1 (indicating that two or more server log strings are different). If there are duplicates, the LASM alerts the application code developer to remove or modify the application code that produced the duplicate application server log strings. The method also applies the QLA to server log strings to identify issues with the server log. These issues can include providing suggestions for duplicate server log strings to be removed. The system can compare application code server log strings with the optimized server log string rules engine to determine which application code server log strings can be optimized to reduce use of a server log memory.

In a further embodiment, the QLA identifies issues with the server log can include log entry repetitions, package names, needless key value pairs, verbosity, lengthy log, length limits on parameters, printing headers, caching, usage of package names, validation of logging levels, and the like.

In an embodiment, the QLA validates each line of the application code server log and its content based on the rules engine. The QLA scans every application code server log string for issues and post processing to optimization suggestions based upon the rules engine.

In an embodiment, the QLA uses a variant of the Jaro similarity algorithm to compare two application code server log strings character by character and take into account the number of matching characters and the number of transpositions need to transform one application code server log string into the other, wherein distance ranges from 0 for different application code server log strings to 1 indicating an identical application code server log string.

In a further embodiment, the QLA scans every application code server log string for violations of the rules engine and the developer application code is not finally complied until the violations are corrected.

In still a further embodiment, the system for analyzing the quality of data in a server log file comprises a network device having logic, processors, memory, circuitry, interfaces, and/or code for inputting data, directing the data to an application, outputting the data from an application and registering in the server log file the activities occurring on the network device. The network device executes a quality log analyzer plugin to identify and report logging issues within the server log file. The network device uses the quality log analyzer plugin to provide optimization recommendations for the server log file. The network device then compares the server log with in-memory data to provide suggestions on which similar server log string could be selected in real-time to optimize server log quality.

In an embodiment, the QLA uses a variant of the Jaro similarity algorithm to compare two application code server log statement entries character by character and take into account the number of matching characters and the number of transpositions need to transform one application code server log string entry into the other, wherein distance ranges from 0 for different log entries to 1 indicating an identical application code server log string entry.

In a further embodiment, a variant of the Jaro similarity algorithm is a Jaro-Winkler distance algorithm that adds a prefix bonus to the Jaro similarity score, giving additional weight to matching characters that appear at the beginning of the application code server log strings being compared, such that distance is defined as the inversion of the value (distance=1−similarity).

In still another embodiment, the rules engine includes scoring rules for the application code server log strings including: the length of characters in certain log strings; identifying duplicate words in a log string; log health checks; masking rules; parameters related to the final log entry; HTTP pooling; caching; jdbc statistics; payload requests; and the like.

In an embodiment the analyzer component is configured to produce an overall report of the logs and an app wise report for each application data present in the log. The analyzer component can rate each application by the number of records it has stored in the log.

The foregoing paragraphs have been provided by way of general introduction and are not intended to limit the scope of the invention disclosed herein or the claims set forth herein. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an overflow diagram of the Quality Log Analyzer;

FIG. 2 illustrates an embodiment of the Quality Log Analyzer as an onboarded scanning component;

FIG. 3 provides an embodiment of the Quality Log Analyzer as an IDE plug-in;

FIG. 4 an overview system flow diagram indicating key components of the Quality Log Analyzer;

FIG. 5 provides an overview of the rules engine;

FIG. 6 provides an example of the log analyzer suggestion module output; and

FIG. 7 provides an illustration of a computing platform.

The figures are described in greater detail in the description and examples below, are provided for purposes of illustration only, and merely depict typical or example embodiments of the disclosure. The figures are not intended to be exhaustive or to limit the disclosure to the precise form disclosed. It should also be understood that the disclosure may be practiced with modification or alteration, and that the disclosure may be limited only by the claims and the equivalents thereof.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure are directed to a system and method for analyzing the quality of data in a server or network component a log file. The system imports a quality log analyzer (QLA) plugin into an integrated developer environment (IDE). The developer application code is compiled within the IDE. The QLA plugin invokes a log analyzer suggestion module (LASM) during the developer application code runtime. During the application code runtime, the LASM, reads the developer application code to parse server log statements associated with the developer application code. The LASM analyzes the developer application code server log statements for similarities, and calculates the similarity between two or more application code server log statements to determine if they are identical, similar, or unrelated. The system uses these comparisons along with an optimized server log statement rules engine to determine which application code server log statements can be optimized to reduce use of the server log memory.

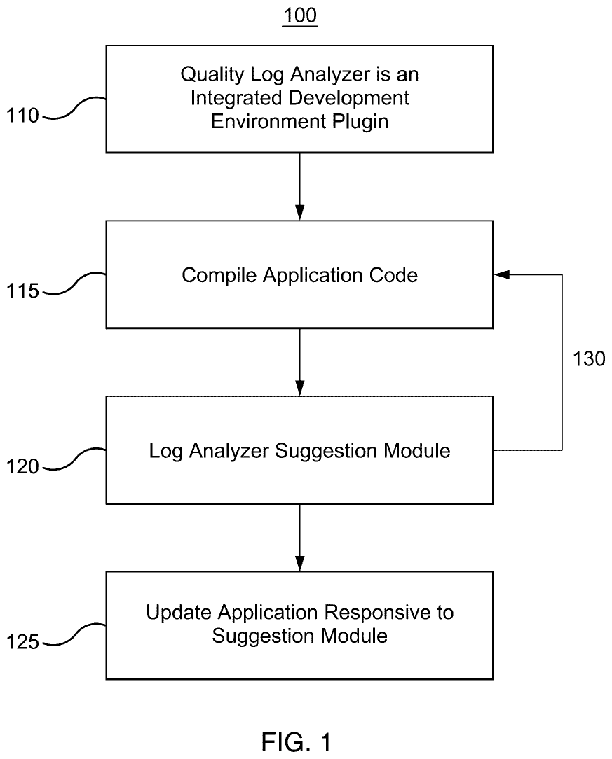

Turing now to FIG. 1, an overview of the Quality Log Analyzer (QLA). The QLA is a plugin that can exist within an integrated development environment (IDE) as shown in step 110. In an embodiment, the QLA is imported into an IDE. A software developer uses the IDE to create and refine software code. The developer creates and/or compiles the code within the IDE environment 110.

When the application code is complete and ready to be compiled, the IDE begins the code compilation in step 115. Once the code is compiled the QLA plugin invokes a log analyzer suggestion module (LASM) at step 120 from inside the QLA plugin at runtime.

The LASM 120 that is invoked during runtime provides feedback to the developer regarding the QLA analysis of the sever logs that are generated by the code. The LASM 120 is able to report logging issues like repetitions, lengthy log statements, package names, etc. It also provides suggestions regarding similar or identical server log entries that are generated by the application to the developer. The QLA compares the application log with its in-memory data or rules engine to enable the LASM 120 to provide suggestions on which similar log statement code that could be selected in real-time that would optimize the server log's memory usage.

The LASM 120 operating within the IDE results in a feedback look 130 wherein the application code is and analyzed and code improvements are suggested by the LASM 120 and those improvements are recompiled at step 115. Once the code is finalized and the optimization suggestions have been satisfied, the complete updated code is finalized at step 125.

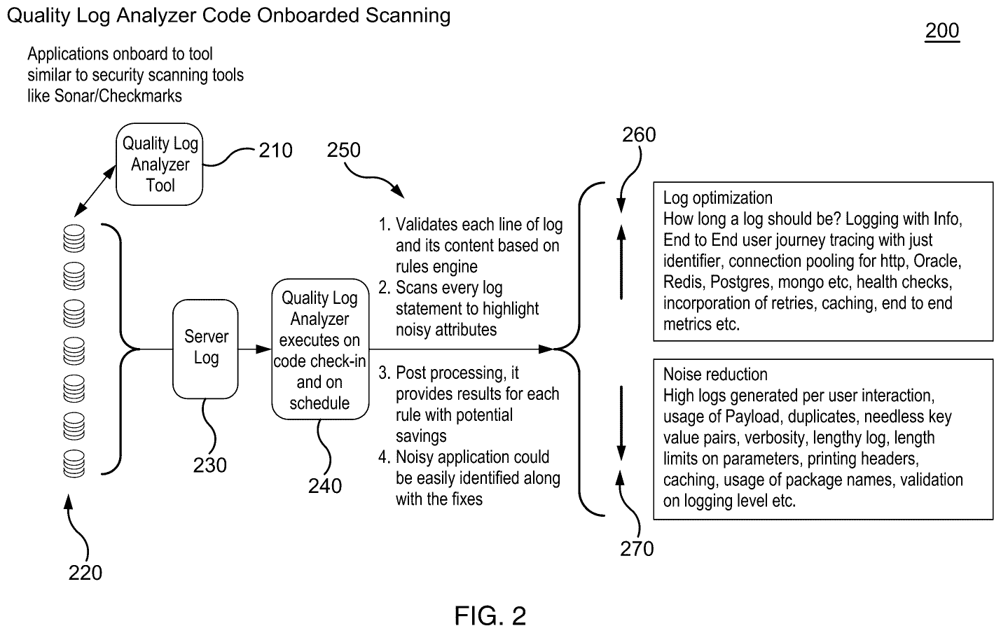

Turning next to FIG. 2, the QLA code onboarded scanning process is illustrated. The method onboarded scanning method 200 illustrates a process for an application to be onboarded to into a network server environment 220. The QLA tool 210 executes within the network server environment 220. One or more Applications execute within the network server environment 220 and generate server logs 230.

Further in FIG. 2, the QLA tool 210 scans and analyzes the server log upon code check-ins and/or on a schedule in step 250. The QLA tool 210 validates each line of the server logs and the contents of each log entry responsive to a rules engine. The QLA tool 210 scans every log entry for noisy attributes as defined by the rules engine and highlights those attributes. Post analysis, the QLA tool 210 provides results for each the noisy attributes and provides suggestions for how these noisy attributes can be eliminated or optimized to improve storage efficiency with the server logs 230.

The QLA tool 210 can quickly identify noisy applications that create server log efficiency and storage issues. The QLA tool 210 also identifies potential fixes within the application or application code to improve efficiency and/or storage issues as disclosed in step 260.

The QLA tool 210 seeks to optimize the log entries 260 within the server logs. Log optimization considers such factors as how long a log should be; the logging information; end to end user journey tracing with just identifiers; connection pooling for http; Oracle/Redis/Postgres/Mongo platform attributes; health checks, incorporation of retries; caching; end to end metrics; and the like.

The QLA tool 210 also seeks to reduce noise 270 within the server logs. The QLA tool 210 analyzes the server logs to determine if log entries have a high number of log entries generated per user interaction; the usage of payload; duplicates; needless key value pairs; verbosity; lengthy logs; length limits on parameters; printing headers; caching; usage of package names; validation on logging level; and the like.

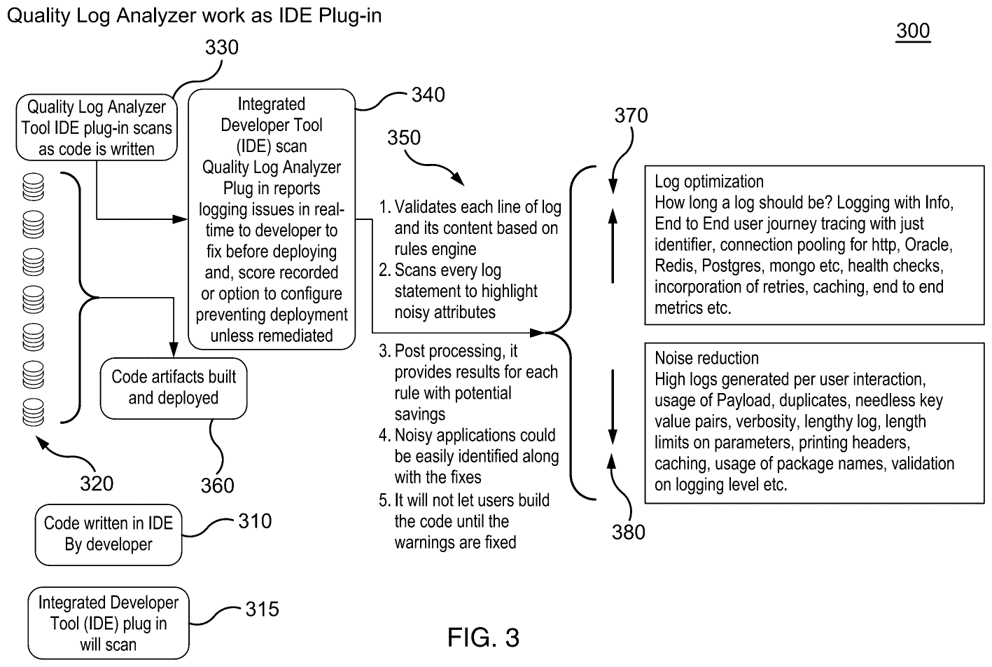

In a further embodiment in FIG. 3, the QLA is described as integrated development environment (IDE) plugin tool 300. The IDE QLA plugin tool 300 allows applications to be optimized for server log efficiency at the code level. The QLA plugin tool 300 is imported into the IDE at step 315. In the embodiment, the developer writes, tests, or analyzes code for execution on a server 320 at step 310. Upon compiling or running code within the IDE QLA plugin tool 300 scan the code and its output the server logs 320 at step 330.

In an embodiment, the IDE QLA plugin tool 300 scan the server logs entries that are generated by the currently executing application to determine if there are server logging issues of concern happening with the application at step 330. In the embodiment, the IDE QLA plugin tool 300 scans and analyzes the server log upon code check-ins and/or on a schedule in step 350. The IDE QLA plugin tool 300 validates each line of the server logs and the contents of each log entry responsive to the rules engine. The IDE QLA plugin tool 300 scans every log entry for noisy attributes as defined by the rules engine and highlights those attributes. Post analysis, the IDE QLA plugin tool 300 provides results for each the noisy attributes and provides suggestions for how these noisy attributes can be eliminated or optimized to improve storage efficiency with the server logs 320.

The IDE QLA plugin tool 300 can quickly identify noisy applications that create server log efficiency and storage issues. The IDE QLA plugin tool 300 also identifies potential fixes within the application or application code to improve efficiency and/or storage issues as disclosed in step 350. In an embodiment, for example, the IDE QLA plugin tool 300 will at step 370, will analyze and compare a plurality of sever log entries for duplicates, end to end user journey tracing, connection pooling for http, Oracle, Redis, Postgres, Mongo, health checks, incorporation of retries, caching, end to end metrics, etc. Data that is duplicated or irrelevant to testing and troubleshooting can be discarded.

The IDE QLA plugin tool 300 seeks to optimize the log entries 360 within the server logs. Log optimization uses a rules engine 380 to compare and considers such factors as how long a log should be; the logging information; end to end user journey tracing with just identifiers; connection pooling for http; Oracle/Redis/Postgres/Mongo platform attributes; health checks, incorporation of retries; caching; end to end metrics; and the like.

The IDE QLA plugin tool 300 also seeks to reduce noise within the server logs via the rules engine 380. The IDE QLA plugin tool 300 analyzes and compares the entries in the server logs to a database of predetermined optimized server log entries representing the rule engine 380, to determine if the server log entries have a high number of log entries generated per user interaction; the usage of payload; duplicates; needless key value pairs; verbosity; lengthy logs; length limits on parameters; printing headers; caching; usage of package names; validation on logging level; and the like.

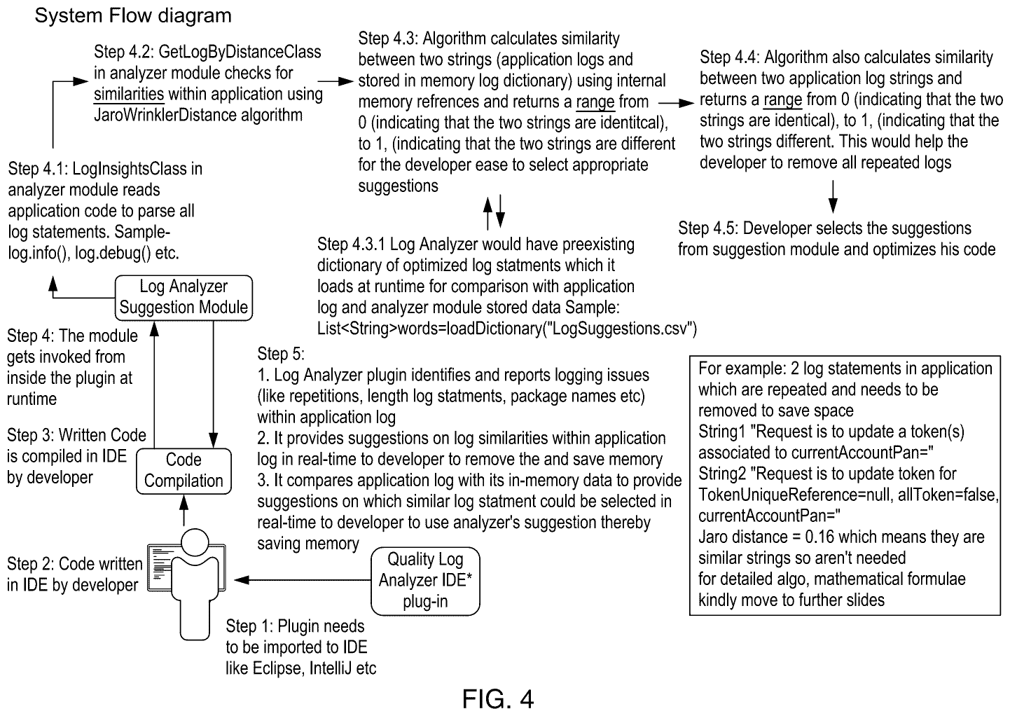

Turning now to FIG. 4, an overall system flow diagram 400 is provided for using the integrated development environment (IDE) plugin tool 300 described in FIG. 3 above. An IDE is a software application that provides comprehensive facilities for software development. An IDE normally consists of at least a source-code editor, build automation tools, and a debugger. In an embodiment, at step 1 the QLA 300 plugin is imported into the IDE platform. The QLA 330 plugin can then analyse any code that is written within the environment. In a typical example the developer writes, uploads, or test software application code at step 2.

Once the developer has written, uploaded, or tests the application software code, the application software code is then compiled in the IDE 310 at step 3. This application software code compilation triggers QLA plugin tool 300 to activate and scan the application software code as it runs in real-time within the IDE. The QLA plugin tool 300 triggers the LASM 120 to activate and report the results of the QLA plugin tool 300 analysis in step 4.

At step 5 the LASM 120 can alert the developer to sever logging issues like repetitions, lengthy log statements, package names, etc. It also provides suggestions regarding similar or identical server log entries that are generated by the application to the developer. The QLA plugin tool 300 compares the application log with its in-memory data or rules engine to enable the LASM 120 to provide suggestions on which similar log statement code that could be selected in real-time that would optimize the server log's memory usage. This feedback is provided to the developer who can then update the application software code accordingly in step 3.

The LASM 120 is able to provide the developer with suggestions based on the analysis by the QLA plugin tool 300. Further in FIG. 4, the QLA plugin tool 300 analyses each line of a plurality of server log entries generated by the application software code to parse all the code associated with generating the application server log strings as shown in step 4.1.

The similarities between server log statement entries are determined using a Jaro-Wrinkler Distance algorithm in step 4.2. The a Jaro-Wrinkler Distance algorithm calculates similarity between two strings (application logs and stored in memory log dictionary) using internal memory references and returns a range from 0 (indicating that the two strings are identical) to 1 (indicating that the two strings are different). The QLA plugin tool 300 can suggest duplicate server log entries for removal if they the log type is INFO (information). The QLA plugin tool 300 can also suggest duplicate server log entries to remain in the log if they the log type is DEBUG (testing). The LASM 120 alerts the developer to this comparisons and suggestions so that the developer can make appropriate adjustments in the software application code to minimize duplicates in the server log.

The Jaro-Wrinkler Distance algorithm in step 4.2 is also used at step 4.3.1 to compare server log entries generated by the application software code with a rules engine. In an embodiment, the rules engine is a pre-existing dictionary of optimized log statements which loads at run-time for comparison with application log and analyser module stored data sample. The QLA plugin tool 300 analyses both the application software code generated entries in the server logs 220, 320 for comparison for similarities and for comparison with optimized server log entries in the rules engine in order to make recommendation to the developer regarding which server log entries should be eliminated or optimized. These recommendations can be produced as a “.csv” file for further analysis by the developer.

Further in step 4.4 the Jaro-Wrinkler Distance algorithm also calculates similarity between two application log strings and returns a range from 0 (indicating that the two strings are identical) to 1 (indicating that the two strings are different). This would help the developer to remove all repeated logs. The LASM 120 reports the findings of this analysis to the developer in step 4.5 so the code can be updated and/or corrected.

The Jaro-Wrinkler Distance algorithm is a measure of the similarity between two strings. It is a variant of the Jaro similarity algorithm (simj), which compares two strings character by character and takes into account the number of matching characters and the number of transpositions needed to transform one string into the other. Resulting distance ranges from 0, indicating that the two strings are completely different, to 1, indicating that the two strings are identical.

The Jaro-Winkler distance algorithm adds a prefix bonus to the Jaro similarity score, which gives additional weight to matching characters that appear at the beginning of the strings being compared. This helps the algorithm to more accurately measure the similarity between strings that may have similar but not necessarily identical prefixes.

The higher the Jaro-Winkler distance for two strings is, the less similar the strings are. The score is normalized such that 0 means an exact match and 1 means there is no similarity. So, distance is defined as the inversion of that value (distance=1−similarity)

Jaro similarity (simj) between two strings is defined as: simj=⅓*( m/|s1|+m/|s2|+(m−t)/m ) where:
m: Number of matching characters (Two characters from s1 and s2 are considered matching if they are the same and not farther than [max(|s1|, |s2|)/2]−1 characters apart.)
   |s1|, |s2|: The length of the first and second strings, respectively
t: Number of transpositions: Calculated as the number of matching (but different sequence order) characters divided by 2.

Jaro-Winkler similarity (simw) is defined as: simw=simj+lp(1−simj) where:
simj: The Jaro similarity between two strings, s1 and s2
l: Length of the common prefix at the start of the string (max of 4 characters)
p: Scaling factor for how much the score is adjusted upwards for having common prefixes. Typically, this is defined as p=0.1 and should not exceed p=0.25

Jaro-Winkler distance is defined as: (dw)=1−simw, where simw is Jaro-Winkler similarity.

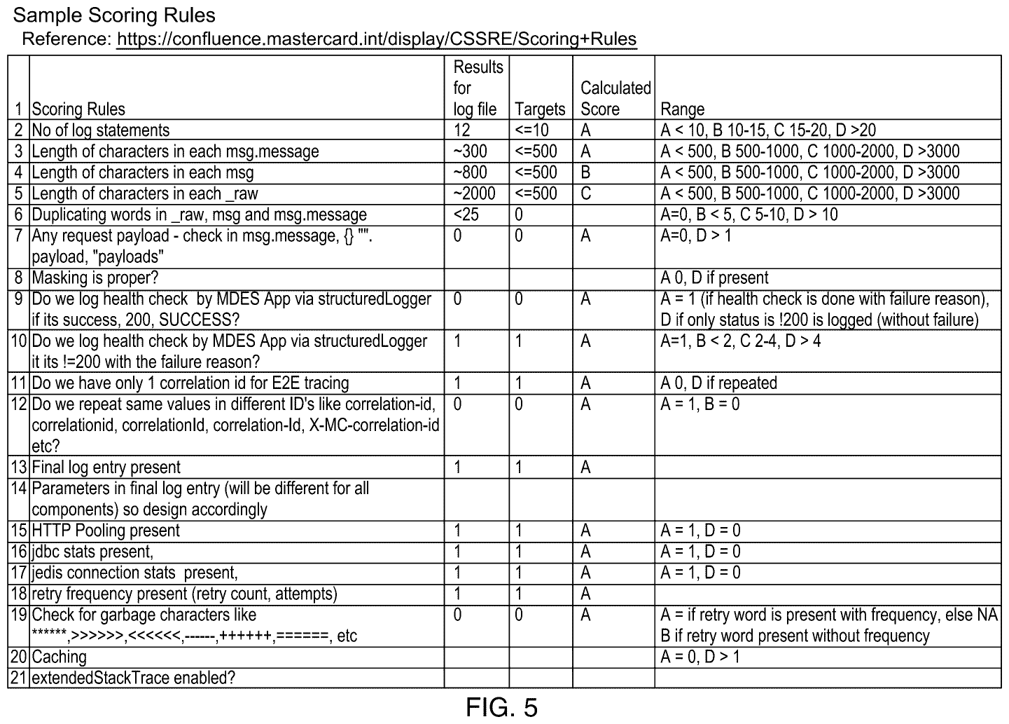

Turning now to FIG. 5, the rules engine 500 is based upon an optimized set of log entries that provide the information needed within a server log while also efficiently maximizing storage space and efficiencies. These optimized set of log entries are compared, using the Jaro-Winkler distance algorithm, against actual log entries generated by the application software code. The actual log entries generated by the application software code are scored against the optimized entries of the rules engine to determine their compliance with the ideal code format and structure.

Further in FIG. 5, the rules engine can include any number of log entry characteristics as seen in the of 20 scoring rule types. These scoring rules can include the following:
No of log statements
Length of characters in each msg.message
Length of characters in each msg
Length of characters in each _raw
Duplicating words in _raw, msg and msg.message
Any request payload
Health check by MDES App
Do we have only 1 correlation id for E2E tracing
Final_log entry present
HTTP Pooling present
jdbc stats present
jedis connection stats present
retry frequency present

Each of these rules have their own individual targets and scoring algorithms as illustrated in FIG. 5.

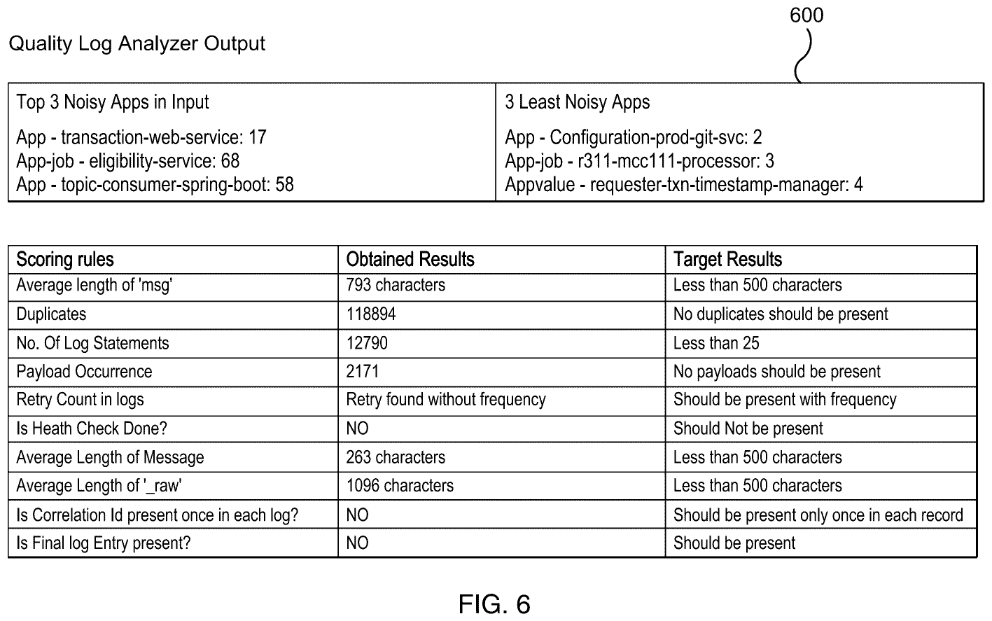

FIG. 6 illustrates an example output of the QLA plugin tool 300 as a “.csv” file for review by a software application developer. Here the QLA plugin tool 300 is indicating which apps are noisy within a distributed network environment. Components within the server logs contributing to “noise” are the average length of the ‘msg,’ the number of duplicates within the server log, payload occurrence, the retry count in logs, health checks, average length of message, average length of ‘_raw,’ is correlation ID present in each log, and is the final log entry present? The obtained results are compared with a set of target results to see if the log entries meet the threshold requirement for a low noise application.

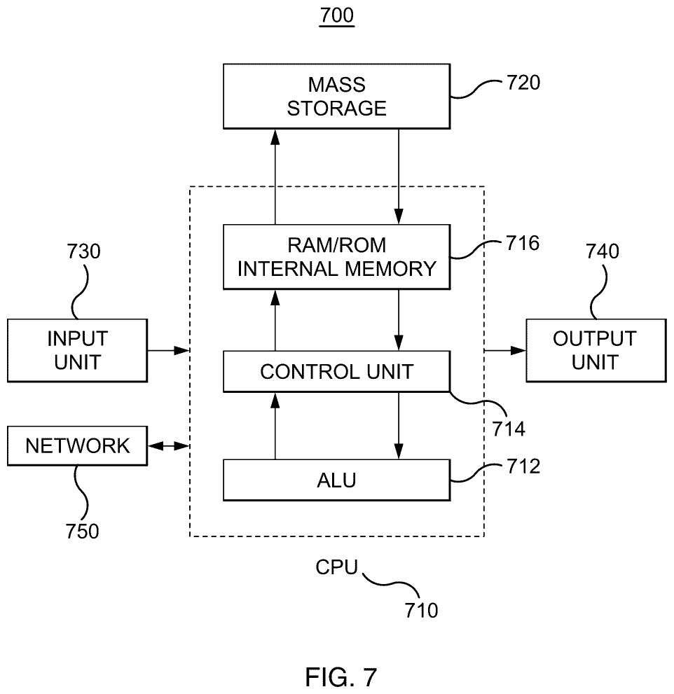

FIG. 7 illustrates a general-purpose computer 700 connected to a network 750. Indeed, in embodiments, the general-purpose computer 700 may also be a server. The general-purpose computer 700 comprises a central processing unit 710 in communication with a mass storage device 720. The general-purpose computer 700 receives inputs from an input unit 730. The general-purpose computer 700 produces output via an output unit 740. The general-purpose computer 700 is controlled using a microprocessor or central processing unit 710. The general processing unit 710 is comprised of an arithmetic logic unit 712, a control unit 714, and an internal memory 716. More generally, the general-purpose computer 700 is a data processing apparatus of the disclosure. Typically, the general-purpose computer 700 according to embodiments of the disclosure is a computer device such as a personal computer or a terminal connected to a server. Indeed, in embodiments, the general-purpose computer 700 may also be a server.

Accordingly, in so far as embodiments of the disclosure have been implemented, at least in part, by a software-controlled general-purpose computer 700, it will be appreciated that a non-transitory machine-readable medium or memory 720 carrying such software, such as an optical disk, a magnetic disk, semiconductor memory or the like, is also considered to represent an embodiment of the present disclosure.

Numerous modifications and variations of the present disclosure are possible in light of the above teachings. It is therefore to be understood that within the scope of the appended claims, the disclosure may be practiced otherwise than as specifically described herein.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognize that various features of the described embodiments may be combined in any manner suitable to implement the technique.

1. A computer-implemented method, comprising:
importing, by a processor, a quality log analyzer (QLA) plugin into an integrated developer environment (IDE);
compiling developer application code within the IDE; wherein during a developer application code runtime, the application code generates a plurality of server log string entries; and wherein the QLA,
analyzes the developer application code to parse portions of the application code that generates server log strings;
analyzes the plurality of server log strings for similarities, and calculates the similarity between to two or more server log strings to determine if they are identical, similar, or unrelated; and
providing the QLA with a rules engine based upon an optimized server log string database for comparison with the plurality of application code generated server log strings, wherein the QLA,
calculates similarities between the plurality of application code server log strings and scores the application code server log strings based upon their similarities with the optimized server log string database; and
invoking a log analyzer suggestion module (LASM) from inside the QLA plugin during the developer application code runtime to:
identify issues with the application code for the server log;
provide suggestions for duplicate application code server log strings to be removed; and
using the application code server log scores to determine which application code server log strings can be optimized to reduce use of a server log memory.

2. A computer-implemented method of claim 1, wherein identified issues with the application server log can include: log entry repetitions, needless key value pairs, verbosity, lengthy log, length limits on parameters, printing headers, caching, usage of package names, and validation of logging levels.

3. A computer-implemented method of claim 1, wherein the QLA validates each line of the application code server log strings and their contents based on the rules engine.

4. A computer-implemented method of claim 1, wherein the QLA scans every application code server log strings for issues and post processing, the LASM provides optimization suggestions based upon the rules engine.

5. A computer-implemented method of claim 1, wherein the QLA uses a variant of the Jaro similarity algorithm to compare two application code server log strings character by character and take into account a number of matching characters and a number of transpositions needed to transform one application code server log string into the other, wherein distance ranges from 0 for a different application code server log string to 1 indicating an identical application code server log string.

6. A computer-implemented method of claim 1, wherein the QLA scans every application code server log string to highlight noisy attributes.

7. A computer-implemented method of claim 6, wherein the noisy attributes and their optimization recommendations are identified based upon the rules engine.

8. A computer-implemented method of claim 7, wherein the QLA scans every application code server log strings for violations of the rules engine and prevents an application code final compilation until the violations are corrected.

9. A system for analyzing a quality of data in a server log file, the system comprising:
a network device having logic, processors, memory, circuitry, interfaces, and/or code for inputting data, directing the data to an application, outputting the data from an application and registering in a server log, a plurality of server log strings that reflect activities occurring on the network device;
the network device executing a quality log analyzer (QLA) plugin to identify and report logging issues with the server log strings in the server log,
the network device using the QLA plugin to compare two or more of a plurality of the sever log strings for duplicates and similarities to provide optimization recommendations for which similar server log strings could be stored or removed in real-time to optimize server log quality; and
the network device using the QLA for comparing the server log strings in the server log with a rules engine database of optimized server log strings to provide scoring suggestions for which server log strings could be stored or removed in real-time to optimize server log quality.

10. A system for analyzing a quality of data in an application server log file;
wherein the system has
a processor, memory, circuitry, and logic for importing and executing a quality log analyzer (QLA) plugin into an integrated developer environment (IDE); wherein a developer application code is compiled within the IDE; and wherein,
the QLA analyzes the developer application code to parse the portions of the application code that generates server log strings;
the developer application code executing within the IDE during an application code runtime and wherein the developer application code generates a plurality of server log strings;
the QLA analyzes the plurality of server log strings for similarities, and calculates the similarity between to two or more server log strings to determine if they are identical, similar, or unrelated; and
the QLA uses a rules engine database of optimized server log strings for comparison with the plurality of server log strings, and wherein the QLA scores the server log strings based upon their similarities with the optimized server log strings; and wherein,
the QLA invokes a log analyzer suggestion module (LASM) during the application code runtime to:
identify server log issues;
provide suggestions for any duplicate server log strings to be removed; and
use the server log strings scores to determine which server log strings can be optimized to improve server log storage.

11. The system according to claim 10, wherein identified issues with the server log can include log entry repetitions, needless key value pairs, verbosity, lengthy log entries, length limits on parameters, printing headers, caching, usage of package names, or validation of logging levels.

12. The system according to claim 10, wherein the QLA validates each server log string and its contents based on the rules engine.

13. The system according to claim 12, wherein the QLA scans the plurality of application code server log strings for issues and post processing, the LASM provides optimization suggestions based upon the rules engine.

14. The system according to claim 10, wherein the QLA scans the plurality of application code server log strings to highlight noisy attributes.

15. The system according to claim 14, wherein the noisy attributes and their optimization recommendations are identified based upon the rules engine.

16. The system according to claim 15, wherein the QLA the plurality of application code server log strings for violations of the rules engine and prevents the application code's final compilation until the violations are corrected.

17. The system according to claim 10, wherein the QLA uses a variant of the Jaro similarity algorithm to compare two application code server log strings character by character and take into account the number of matching characters and the number of transpositions need to transform one application code server log string into the other, wherein distance ranges from 0 for different log entries to 1 indicating an identical application code server log entry.

18. The system according to claim 17, wherein the variant of the Jaro similarity algorithm is a Jaro-Winkler distance algorithm that adds a prefix bonus to the Jaro similarity score, giving additional weight to matching characters that appear at the beginning of the application code server logs being compared, such that distance is defined as the inversion of the value (distance=1−similarity).

19. The system according to claim 10, wherein the rules engine includes scoring rules for the plurality of application code server log strings that are based upon the length of characters in certain server log strings; duplicate words in the server log strings; log health check; masking rules; parameters related to the final log entry; HTTP pooling; caching; jdbc statistics; and/or payload requests.

20. The system according to claim 19, wherein the rules engine compares a target value of the server log string scores with an actual value for the server log string scores to determine outliers in the server log strings that can be optimized for better storage and processing.
